(19) United States
(12) Patent Application Publication
(10) Pub. No.: US 2013/0018584 A1
(43) Pub. Date: Jan. 17, 2013

(54) ELECTRONIC DEVICE WITH WORK-MODE SWITCHING FUNCTION AND METHOD THEREOF

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/223,190

(22) Filed: Aug. 31, 2011

(30) Foreign Application Priority Data
Jul. 12, 2011 (CN) 201110194334.3

(51) Int. Cl. G06F 19/00; G01J 3/00

(52) U.S. Cl. 702/1; 356/51

(57) ABSTRACT

The electronic device controls an environment parameter detecting unit to detect the environment parameters of the environment which the electronic device is placed in periodically. It determines the environment parameter range which the detected environment parameters fall into. Determines whether the environment parameter range which the detected environment parameters fall into has changed, and switches a current working mode to one of the working mode sets for the environment range which the environment parameters fall into.

### BACKGROUND

1. Technical Field

The present disclosure relates to an electronic device with work-mode switching function and a method for switching the working mode of the electronic device.

2. Description of Related Art

Some electronic devices set a number of work-modes for different work environments. Taking the cell-phone for example, a ring mode, a mute mode, and a vibration mode are set for the cell-phone. When in a meeting environment, the mute mode or vibration mode is generally activated by the user. When in a noisy environment, a ring mode is generally activated by the user. However, due to the working mode of the electronic device needing to be set manually, when entering a new environment, the user may forget to change the working mode of the electronic device. For example, if the user forgets to change the working mode of the electronic device from the ring mode to the mute mode or vibration mode when having a meeting, an incoming call will disturb the meeting.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device with work-mode switching function, in accordance with an exemplary embodiment.

FIG. 2 is a flowchart of a method for automatically switching the working mode of the electronic device of FIG. 1.

### DETAILED DESCRIPTION

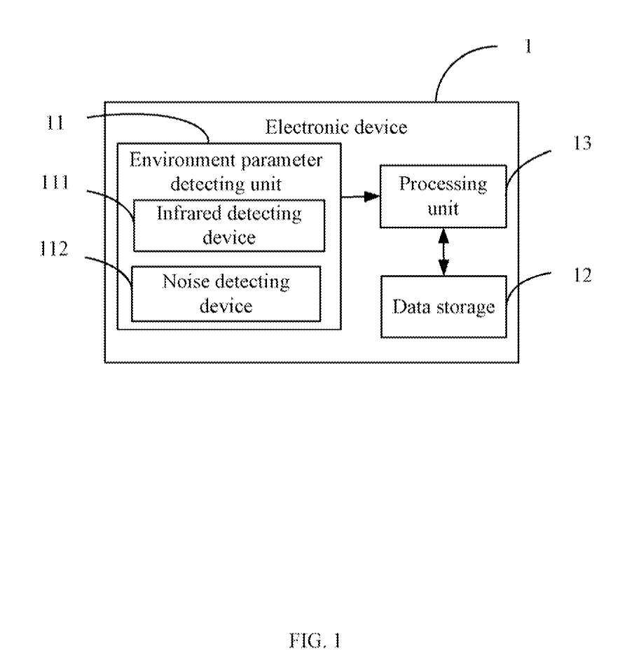

Referring to FIG. 1, the electronic device 1 includes an environment parameter detecting unit 11, a data storage 12, and a processing unit 13. The environment parameter detecting unit 11 detects the environment parameters. The detected environment parameters are transmitted to the processing unit 13 to determine a current environment, which the environment parameters correspond to. In the exemplary embodiment, a number of environment parameter ranges are set according to the environment parameters. The detailed of a way of setting environment range will be described below.

In the exemplary embodiment, the environment parameter detecting unit 11 is an infrared detecting device 111 and a noise detecting device 112.

Generally, human body generates infrared spectrophotometry, the infrared detecting device 111 can sense the infrared spectrophotometry to generate infrared signal. When the electronic device 1 is in an environment where many people exist (hereinafter, a many-people environment), the strength value of the infrared signal detected by the infrared detecting device 111 will be strong. When the electronic device 1 is in an environment where few people exist (hereinafter, a few-people environment), the strength value of the infrared signal detected by the infrared detecting device 111 will be weak. In this exemplary embodiment, in order to determine the environment, which the electronic device 1 is in, is the many-people environment or the few-people environment, a strong signal range and a weak signal range are preset. If the strength value, which the infrared detecting device 111 detects falls into the strong signal range, the processing unit 13 determines that the electronic device 1 is in the many-people environment. If the strength value, which the infrared detecting device 111 detects falls into the weak signal range, the processing unit 13 determines that the electronic device 1 is in the few-people environment.

Almost every object can generate infrared spectrophotometry, but different objects generates different infrared spectrophotometry, so the strength values of different objects which the infrared detecting device 111 detects will be different. If the electronic device 1 is moving, namely, in a moving environment, due to the objects the infrared detecting device 111 detected are changing continually, the infrared signals detected by the infrared detecting device 111 are also changing continually. If the electronic device 1 is not moving, namely in a static environment, due to the objects which the infrared detecting device 111 detects do not change, the infrared signals detected by the infrared detecting device 111 also do not changed. Therefore, in this exemplary embodiment, if the infrared signals detected by the infrared detecting device 111 do not change in a predetermined time, the processing unit 13 determines the electronic device 1 is in a static environment. If the infrared signals detected by the infrared detecting device 111 are changing continually in a predetermined time, the processing unit 13 determines the electronic device 1 is in a moving environment.

The noise detecting device 112 detects the noise value of the environment where the electronic device 1 is placed in. If the electronic device 1 is in a noisy environment, the noise value detected by the noise detecting device 112 is high. If the electronic device 1 is in a quiet environment, the noise value detected by the noise detecting device 112 is low. In this exemplary embodiment, in order to determine the electronic device 1 is in a noisy environment or a quiet environment, a lower noise value range and a higher noise value range is preset. If the noise value which the noise detecting device 112 detects falls into the lower noise value range, the processing unit 13 determines that the electronic device 1 is in the quiet environment. If the noise value which the noise detecting device 112 detects falls into the higher noise value range, the processing unit 13 determines that the electronic device 1 is in the noisy environment.

In this exemplary embodiment, the environment parameter ranges are set according to the strength values of the infrared signals detected by the infrared detecting device 111, and the noise value detected by the noise detecting device 112. Each environment parameter range is set a working mode, as shown in Table 1. The working mode set for each environment parameter range is stored in the data storage 12.

TABLE 1

| | |
|---|---|
| weak signal range, signal have no change, lower noise | mute mode or |
| value range | vibration mode |
| weak signal range, signal have change, lower noise | vibration mode or |
| value range | ring mode |
| strong signal range, signal have no change, lower noise | vibration mode or |
| value range | mute mode |
| strong signal range, signal have change, lower noise | vibration mode |
| value range | |
| weak signal range, signal have no change, higher noise | Ring mode |
| value range | |
| weak signal range, signal have change, higher noise | Ring mode plus |
| value range | vibration mode |
| strong signal range, signal have no change, higher | Ring mode plus |
| noise value range | vibration mode |
| strong signal range, signal have changed, higher noise | Ring mode plus |
| value range | vibration mode |

If the signal value detected by the infrared detecting device 111 falls into the weak signal range and has no change in a predetermined time, and the noise value detected by the noise detecting device 112 falls into the lower noise value range, the processing unit 13 determines that the electronic device 1 is in a few-people, static, and quiet environment, such as home, the processing unit 13 switches the working mode of the electronic device 1 to mute mode or vibration mode or ring mode.

If the signal value detected by the infrared detecting device 111 falls into the weak signal range and has continual change in a predetermined time, and the noise value detected by the noise detecting device 112 falls into the lower noise value range, the processing unit 13 determines that the electronic device 1 is in a few-people, moving, and quiet environment. The processing unit 13 switches the working mode of the electronic device 1 to the vibration mode or ring mode.

If the signal value detected by the infrared detecting device 111 falls into the strong signal range and has no change in a predetermined time, and the noise value detected by the noise detecting device 112 falls into the lower noise value range, the processing unit 13 determines the electronic device 1 is in a many-people, static, and quiet environment, such as a meeting room. The processing unit 13 switches the working mode of the electronic device 1 to the vibration mode or mute mode.

If the signal value detected by the infrared detecting device 111 falls into the strong signal range and has continual change in a predetermined time, and the noise value detected by the noise detecting device 112 falls into the lower noise value range, the processing unit 13 determines the electronic device 1 is in a many-people, moving, and quiet environment, such as the user taking the electronic device 1 is walking in a meeting-place, the processing unit 13 switches the working mode of the electronic device 1 to the vibration mode.

If the signal value detected by the infrared detecting device 111 falls into the weak signal range and has no change in a predetermined time, and the noise value detected by the noise detecting device 112 falls into the higher noise value range, the processing unit 13 determines the electronic device 1 is in a few-people, static, and noisy environment, such as the user taking the electronic device 1 sitting in a street with few-people. The processing unit 1 switches the working mode of the electronic device 1 to the ring mode.

If the signal value detected by the infrared detecting device 111 falls into the weak signal range and has continual change in a predetermined time, and the noise value detected by the noise detecting device 112 falls into the higher noise value range, the processing unit 13 determines the electronic device 1 is in a few-people, moving, and noisy environment, such as the user taking the electronic device 1 waking in a street with few people, the processing unit 13 switches the working mode of the electronic device 1 to the ring mode plus vibration mode.

If the signal value detected by the infrared detecting device 111 falls into the strong signal range and has no change in a predetermined time, and the noise value detected by the noise detecting device 112 falls into the higher noise value range, the processing unit 13 determines that the electronic device is in a many-people, static, and noisy environment, such as the user taking the electronic device 1 are resting in the street with many people, the processing unit 1 switches the working mode of the electronic device 1 to the ring mode plus vibration mode.

If the signal value detected by the infrared detecting device 111 falls into the strong signal range and has continual change in a predetermined time, and the noise value detected by the noise detecting device 112 falls into the higher noise value range, the processing unit 13 determines that the electronic device 1 is in a many-people, moving, and noisy environment, such as walking in a street with many people. The processing unit 1 switches the working mode of the electronic device 1 to the ring mode plus vibration mode.

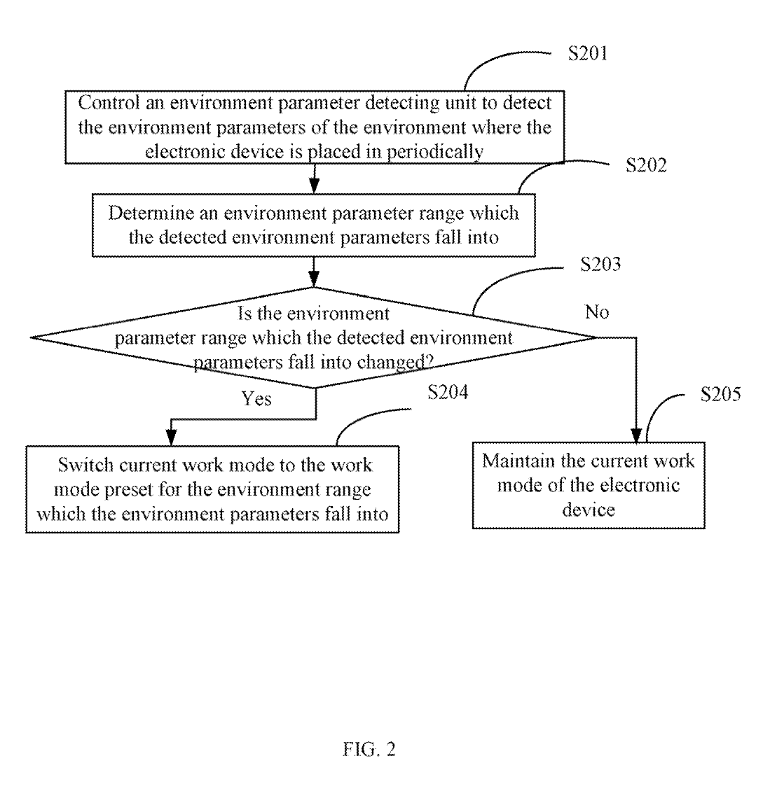

FIG. 2 is a flowchart of a method for automatically switching the working mode of the electronic device of FIG. 1.

In step S201, the processing unit 13 controls the environment parameter detecting unit 11 to detect the environment parameters of the environment where the electronic device 1 is placed in periodically.

In step S202, the processing unit 13 determines the environment parameter range which the detected environment parameters fall into.

In step S203, the processing unit 13 determines whether the environment parameter range which the detected environment parameters fall into is changed.

If the environment parameter range which the detected environment parameters fall into is changed, in step S204, the processing unit 13 switches the current working mode to the working mode preset for the environment parameter range which the environment parameters fall into.

If the environment parameter range which the detected environment parameters fall into is not changed, in step S205, the current working mode of the electronic device 1 is maintained.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device with work-mode switching function, the electronic device comprising:
an environment parameter detecting unit for detecting environment parameters of the environment where the electronic device is placed in;
a data storage for storing a plurality of working mode sets each corresponding to one of a plurality of environment parameter ranges, wherein the plurality of environment parameter ranges are set according to the environment parameters to be detected by the environment parameter detecting unit; and
a processing unit for controlling the environment parameter detecting unit to detect the environment parameters of the environment where the electronic device is placed in periodically, determining the environment parameter range which the detected environment parameters fall into, determining whether the environment parameter range which the detected environment parameters fall into is changed, and switching a current working mode to one of the working mode sets for the environment range which the environment parameters fall into.

2. The electronic device as described in claim 1, wherein the environment parameter detecting unit comprises an infrared detecting device and a noise detecting device.

3. The electronic device as described in claim 2, wherein the environment parameter ranges are set according to a strength value of a infrared signal detected by the infrared detecting device, and a noise value detected by the noise detecting device.

4. The electronic device as described in claim 3, wherein the strength value of the infrared signals detected by the infrared detecting device is for determining the environment where the electronic device is in is a many-people environment or a few-people environment; when the strength value falls into a strong signal range, the processing unit determines that the electronic device is in the many-people environment, and when the strength value falls into a weak signal range, the processing unit determines that the electronic device is in the few-people environment.

5. The electronic device as described in claim 3, wherein the strength value of the infrared signal detected by the infrared detecting device is for determining the environment where the electronic device is in is a moving environment or a static environment, when the strength value of the infrared signal detected by the infrared detecting device does not change in a predetermined time, the processing unit determines the electronic device is in the static environment, and when the strength value of the infrared signals detected by the infrared detecting device is changing continually in a predetermined time, the processing unit determines the electronic device is in the moving environment.

6. The electronic device as described in claim 3, wherein the noise value detected by the noise detecting device is for determining the environment where the electronic device is in is a noisy environment or a quiet environment, when the noise value which the noise detecting device detects falls into a lower noise value range, the processing unit determines that the electronic device is in the quiet environment, and when the noise value which the noise detecting device detects falls into a higher noise value range, the processing unit determines that the electronic device is in the noisy environment.

7. A method for switching working mode of an electronic device, comprising:
storing a plurality of working mode sets each corresponding to one of a plurality of environment parameter ranges, wherein the plurality of environment parameter ranges are set according to the environment parameters to be detected by an environment parameter detecting unit;
controlling the environment parameter detecting unit to detect the environment parameters of the environment where the electronic device is placed in periodically;
determining the environment parameter range which the detected environment parameters fall into; and
determining whether the environment parameter range which the detected environment parameters fall into is changed, and switching a current working mode to one of the working mode sets for the environment range which the environment parameters fall into.

8. The method as described in claim 7, wherein the environment parameter ranges are set according to a strength value of an infrared signal detected by an infrared detecting device, and a noise value detected by a noise detecting device.

9. The method as described in claim 8, wherein the strength value of the infrared signals detected by the infrared detecting device is for determining the environment where the electronic device is in is a many-people environment or a few-people environment; when the strength value, falls into a strong signal range, the processing unit determines that the electronic device is in the many-people environment, and when the strength value falls into a weak signal range, the processing unit determines that the electronic device is in the few-people environment.

10. The method as described in claim 8, wherein the strength value of the infrared signal detected by the infrared detecting device is for determining the environment where the electronic device is in is a moving environment or a static environment, when the strength value of the infrared signal detected by the infrared detecting device does not change in a predetermined time, the processing unit determines the electronic device is in the static environment, and when the strength value of the infrared signals detected by the infrared detecting device is changing continually in a predetermined time, the processing unit determines the electronic device is in the moving environment.

11. The method as described in claim 8, wherein the noise value detected by the noise detecting device is for determining the environment where the electronic device is in is a noisy environment or a quiet environment, when the noise value which the noise detecting device detects falls into a lower noise value range, the processing unit determines that the electronic device is in the quiet environment, and when the noise value which the noise detecting device detects falls into a higher noise value range, the processing unit determines that the electronic device is in the noisy environment.
